(19) United States
(12) Patent Application Publication
(10) Pub. No.: US 2011/0051979 A1
(43) Pub. Date: Mar. 3, 2011

(54) Headphone Ear Tips with Sound Conduit Mounting Structure

(75) Inventors: Noel Lee, Las Vegas, NV (US); David Leung, San Mateo, CA (US)

(73) Assignee: Monster Cable Products, Inc., Brisbane, CA (US)

(21) Appl. No.: 12/651,943

(22) Filed: Jan. 4, 2010

Related U.S. Application Data
(60) Provisional application No. 61/239,714, filed on Sep. 3, 2009.

(51) Int. Cl. H04R 25/00; H04R 1/10

(52) U.S. Cl. 381/380; 181/135

(57) ABSTRACT

An ear tip comprised of two or more contiguous materials, in combination with sound conduit structure comprised of one or more rigid materials, wherein the ear tip mounts upon said sound conduit structure.

### PRIORITY CLAIM

This application claims priority based upon provisional application Ser. No. 61/239,714, filed on Sep. 3, 2009.

### FIELD OF INVENTION

The present invention relates primarily to headphones, specifically, headphone ear tips used with devices providing signals.

### BACKGROUND ART

In-ear headphones have grown increasingly popular with the listening public, particularly with the proliferation of small digital media players. They are convenient due to their small size and low profile, and generally less expensive than larger, over ear headphones. However, typical hard polymer ear tips associated with in-ear headphones suffer from two major shortcomings.

First, even though some in-ear headphones come with a spectrum of different sized ear tips, proper fit is always an issue. In this regard, no single ordinary ear tip shape will fit all users. Moreover, headphones homogeneously composed of ordinary typical polymers such as silicone or rubber can become slippery, particularly when exposed to moisture or oils, and as a consequence can tend to slip out of the user's ear during a listening session.

Second, ordinary hard polymer ear tips do not provide substantial ambient noise attenuation, partly due to the aforementioned fit issues, and partly due to the characteristics of ordinary hard polymers. For example, hard polymers effectively transmit sound, and when used as an ear tip, not only transmit the desired sound from the digital media player, but also outside, undesired noise. Therefore, a listener using ordinary polymer ear tips endures a listening experience of diminished quality compared to other types of headphones with better noise attenuation or noise canceling properties.

Polyurethane foam may be also used as an ear tip. Polyurethane foam conforms to the ear well and is more comfortable than a harder polymer. However, ear tips uniformly comprising polyurethane foam may not produce a good seal, which reduces sound quality. Moreover, a characteristic of polyurethane foam is that it absorbs high frequencies which also can be a further detriment to sound quality.

Based on these shortcomings, there is a need for an ear tip design that achieves a better fit for more listeners, stays in the ear better during use, provides better ambient noise attenuation during use, and provides a conduit for unfettered sound transmission. A better ear tip would combine the sound transmission properties of a hard polymer with the comfort of polyurethane foam while also attenuating ambient noise. Furthermore, there is a corresponding need for an earphone having a mounting structure suitable for insertion into the user's external auditory canal, which simultaneously can accommodate a variety of ear-tip sizes and shapes affixed to it.

### SUMMARY OF THE INVENTION

Herein disclosed is an ear bud assembly including an ear tip comprised of one or more materials, wherein the portions contacting the ear of the listener and the portion providing the sound channel are made of a harder material while, in one embodiment, the cavity of the ear tip is filled with a less dense, more viscous material. Said ear bud assembly further comprises sound conduit structure for mounting the ear tip.

In another related embodiment, an ear tip may be composed of a foam outer contacting portion and a polymer inner sleeve portion, with said inner sleeve protruding in a mushroom shaped flange about the tip, acting as a sound conduit less prone to attenuate or absorb higher frequencies.

In another embodiment of the current inventive concept, an ear tip is composed of two contiguous material layers: an external layer and an internal filling. These layers work together to achieve an ear tip that is stickier, more form fitting within the ear canal, creating a better seal, for a broader audience of listeners, and better able to block out ambient noise thereby insulating the listening experience.

A first, external layer may be composed of an elastomer. In one embodiment, the durometer of the external polymer layer is in the range of 25 to 40 degrees. In one embodiment, said polymer may be silicone. This material is stickier than ordinary silicone and consequently, is less prone to slipping out of a listener's ear, even when exposed to moisture or oils. Moreover, the sound transmission qualities of the external polymer improve the sound quality.

A second, internal filling is composed of a viscous elastomer. In one embodiment, the durometer of the internal polymer filling may be in the range of 5-20 degrees. In one embodiment, this layer may be a silicone gel. This material gives the ear tip a flesh-like elasticity and resilience, thereby achieving a better seal inside the ear. Moreover, the improved seal, and the characteristics of the viscous silicone contribute to better ambient noise attenuation properties compared with ordinary ear tips.

In all embodiments, the ear tip design provides a better bass response than typical ear tips. The tight seal created by the varying densities, along the effect of the vibrations passing through the material(s), among other characteristics of the materials involved, greatly improves the sound quality.

Further alternative embodiments may employ a denser material behind the ear tip shell. This material may provide a better bass response. In an embodiment, this material coupled with the external layer and the portion providing the sound channel may enclose the inner filler material. Such embodiments may include a hollow, tubular sound conduit structure comprised of one or more rigid materials upon which soft ear-tips onto may be mounted. In a preferred embodiment the sound conduit structure may be tapered, having a compound radius along its length. In alternative preferred embodiments, the structure may have a generally conical shape or may comprise cylindrical segments of tapering radii. In all embodiments, the structure has across-sectional diameter appropriate for insertion into a human ear canal. In this regard, at one end, the hollow structure is attached to or integrated into an earphone assembly with a sound source. At the opposite end of the hollow structure, the open mouth has an external angular rim, lip or flange for securing an ear-tip and also helping to form a more complete seal between the ear canal and the ear-tip. In one embodiment, the mouth of the structure may be enclosed by a protective mesh surface constructed of metal, polymer or other material for preventing small objects or detritus from entering the structure.

### BRIEF DESCRIPTION OF THE DRAWINGS

FIG. 1A is the side view and cross-sectional view of an embodiment of the current invention.

FIG. 1B is the side view and cross-sectional view of an embodiment of the current invention.

FIG. 2 is a side view of an embodiment of the current invention.

FIG. 3 is a cross-sectional side view of an embodiment of the current invention.

FIG. 4 is cross-sectional side view of an embodiment of the current invention disposed in a human ear canal.

### MODES FOR CARRYING OUT THE INVENTION

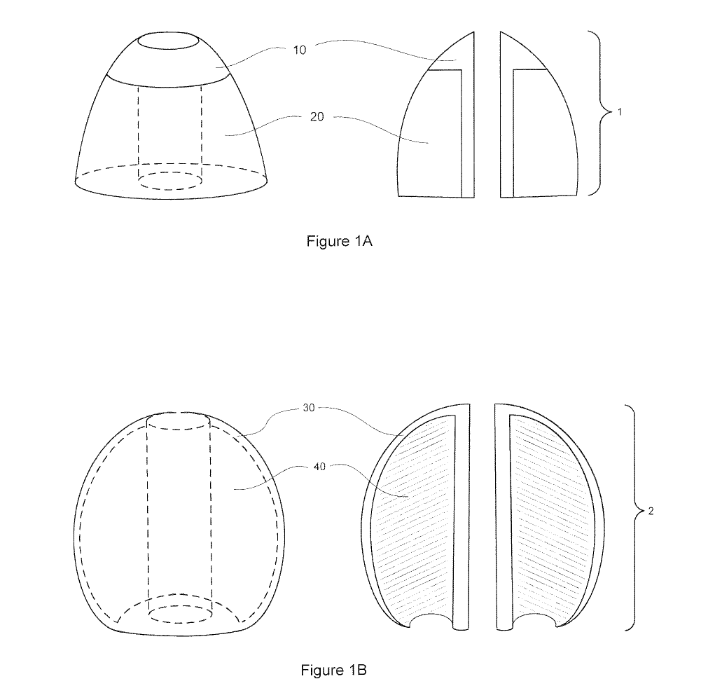

As shown in FIG. 1A, in one embodiment ear tip 1 may be comprised of an inner sleeve with tip of one material surrounded by an external layer of a second material. In one embodiment, the inner sleeve may be a polymer while the external layer is a foam material. In such an embodiment, the inner sleeve may have a protruding mushroom shaped flange at the tip for a better seal against the auditory canal and better transmission of all frequencies into the canal. In a further alternative embodiment, the exterior surface may have antibacterial and/or antimicrobial qualities by virtue of an antibacterial and/or antimicrobial treatment such as AEGIS® Microbe Shield or functionally equivalent technology.

In another embodiment of the current inventive concept, FIG. 1B, an ear tip is composed of two contiguous material layers: an external layer 30 and an internal filling 40. These layers work together to achieve an ear tip 1 that is stickier, more form fitting within the ear canal, creating a better seal, and better able to block out ambient noise, thereby insulating the listening experience, as shown in FIG. 6. In a further alternative embodiment, the exterior surface may have antibacterial and/or antimicrobial qualities.

In all embodiments of the inventive concept, the ear tip surface may be comprised of, or coated with, antimicrobial or antibacterial materials or substances.

A first, external layer 10 and portion 20 may be composed of an elastomer or a foam material. In one embodiment, the durometer of the external polymer layer is in the range of 25 to 40 degrees. In one embodiment, said polymer may be silicone. This material is stickier than ordinary silicone and consequently, is less prone to slipping out of a listener's ear, even when exposed to moisture or oils. Moreover, the sound transmission qualities of the external polymer 10 and portion 20, which provides sound channel 30, improve the sound quality.

A second, internal filling 40 may be composed of a viscous elastomer or other polymer. In one embodiment, the durometer of the internal polymer filling may be in the range of 5-20 degrees. In one embodiment, this layer may be a silicone gel. This material gives the ear tip a flesh-like elasticity and resilience, thereby achieving a better seal 80 inside the ear. Moreover, both the improved seal and the characteristics of the viscous silicone contribute to better ambient noise attenuation properties compared with ordinary ear tips.

Compared with typical ear-tips, in all embodiments, the present ear-tip inventive concept may provide a better bass response by virtue of the seal, and in some embodiments, a better transmission of high frequencies due to the mushroom flange tip. The effect of the vibrations passing through the material(s), the tight seal created by the varying densities, along with the characteristics of the materials involved, greatly improves the sound quality.

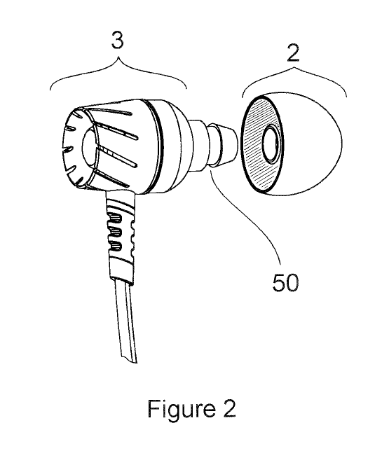

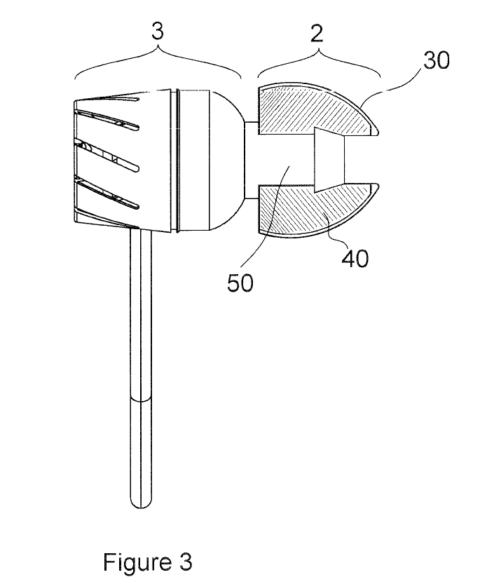

As shown by way of an exploded view in FIG. 2, ear tip 2 mounts to headphone 3 by means of sound conduit structure 50. In alternative embodiments, sound conduit structure 50 may be tapered, may comprise two or more segments of varied radii, or may have an angular flange about the open end. FIG. 3 shows a cross-sectional view of the assembly.

As shown in FIG. 3, further alternative embodiments may employ a denser material 100 behind the ear tip shell.

As shown in FIG. 3, in a further alternative embodiment, a denser mass of rigid material may be disposed behind the ear tip shell. In an embodiment, this mass of material may be disposed in or on the surface of filler material 40, among other configurations. Generally, this mass of material is disposed on the side opposite the side which is typically inserted into a listener's ear canal. This mass may improve bass response, among other things.

In a preferred embodiment of the instant inventive concept, as shown in FIGS. 2 and 3, sound conduit 50 for use with in-ear headphones, comprises a hollow, tubular structure having a first end for attachment to headphone assembly with sound source and a second, open end upon which for concentrically mounting a soft ear-tip as described above and for insertion into a listener's external auditory canal.

In one embodiment, as in FIGS. 2 and 3, the sound conduit structure 50 may have an angular flange about the external circumference of the second, open end. The flange functions to secure an ear-tip 1 or 2 when mounted upon the sound conduit structure. In keeping with its function and purpose, the sound conduit structure and ear tip have an external diameter appropriate for insertion into a listener's auditory canal. For the sound conduit, this diameter is typically not greater than 7.0 mm.

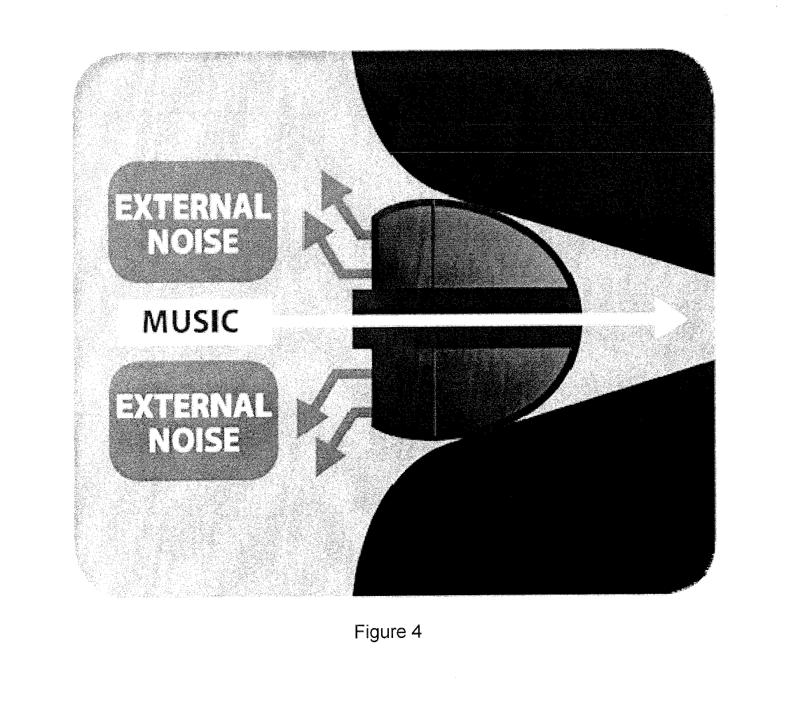

In another possible embodiment, the sound conduit structure may also have a mesh enclosure about its open end to prevent detritus from entering the hollow structure. In an alternative embodiment, the sound conduit structure of the ear-tip mount may be tapered with the first end being wider, and the second, open end being narrower. In a further alternative embodiment, the sound conduit structure comprises two or more cylindrical segments of tapered radii. As indicated by FIG. 4, this tapered shape generally conforms to the shape of the external auditory canal and also allow for easier replacement of interchangeable ear-tips.

1. An ear tip for use with in-ear headphones, having a central channel for transmitting sound, an external surface surrounding said channel composed of elastic material and an internal filling composed of a less dense, more viscous material.

2. An ear tip for use with in-ear headphones, having a central channel for transmitting sound, and comprising a first, external layer composed of soft silicone and a second, contiguous internal layer composed of viscous silicone gel.

3. The ear tip of claim 2 wherein the durometer of said first external layer is in the range of 25 to 40 degrees.

4. The ear tip of claim 3 wherein the durometer of said first external layer is approximately 30 to 35 degrees.

5. The ear tip of claim 2 wherein the durometer of said internal filling is in the range of 5 to 20 degrees.

6. The ear tip of claim 5 wherein the durometer of said internal filling is approximately 10 to 15 degrees.

7. An ear tip for use with in-ear headphones having a central channel and an external surface composed of elastic material enclosing an internal filling composed of viscous material.

8. An ear tip for use with in-ear headphones, having a central channel and an external surface composed of elastic material and internal filling composed of viscous material, and a further denser material located on the side opposite the side which is typically inserted into a listener's ear.

9. An ear tip for use with in ear headphones, having a central channel and an external surface composed of elastic material and internal filing composed of viscous material, and a denser rigid material disposed in said filing and located on the side opposite the side which is typically inserted into a listener's ear.

10. An ear tip for use with in ear headphones, having a central polymer tube, said tube having a mushroom-shaped flange about its tip and further having a foam layer surrounding said central tube.

11. An in-ear headphone assembly, comprising:
a hollow, tubular sound conduit structure having a first end attached to a sound source and a second, open end; and
an ear tip as set forth in any of the foregoing claims concentrically mounted upon said sound conduit structure.

12. The assembly of claim 11, further comprising a flange about the external circumference the sound conduit structure's second, open end for mounting and retaining an ear-tip.

13. The assembly of claim 11, further comprising a mesh enclosure across the second, open end of said sound conduit structure.

14. The assembly of claim 11 wherein the external diameter of said sound conduit structure is not greater than 7.0 mm.

15. The assembly of claim 11 wherein the sound conduit structure is tapered, with the first end being wider, and the second, open end being narrower.

16. The assembly of claim 15 wherein the sound conduit structure comprises two or more cylindrical segments with staggered radii.

17. The assembly of claim 11 wherein the ear tip has a central channel for mounting to said sound conduit structure and an external surface composed of elastic material enclosing an internal filling composed of viscous material.

18. The ear tip of claim 1 wherein the surface of said ear tip is coated with an antimicrobial treatment.

19. The ear tip of claim 1 wherein the surface of said ear tip is coated with an antibacterial treatment.
